(19) United States
(12) Patent Application Publication
(10) Pub. No.: US 2026/0097246 A1
(43) Pub. Date: Apr. 9, 2026

(54) AERIALLY DEPLOYABLE DELIVERY DEVICE

(71) Applicant: Caylym Technologies International, LLC, Fresno, CA (US)

(72) Inventors: Richard Goddard, Fresno, CA (US); James Tadlock, Olympia, WA (US); Alex Goddard, Fresno, CA (US); Kyle Goddard, Fresno, CA (US)

(21) Appl. No.: 18/911,153

(22) Filed: Oct. 9, 2024

(51) Int. Cl. A62C 3/02; B64D 1/16; B65B 7/02; B65B 7/28; B65B 43/26; B65B 51/08; B65D 33/16; B65D 43/02; B65D 45/02; B65D 77/06

(52) U.S. Cl. CPC A62C 3/0235; B64D 1/16; B65B 7/02; B65B 7/2842; B65B 43/26; B65B 51/08; B65D 33/165; B65D 43/0202; B65D 45/02; B65D 77/061; B65D 77/062; B65B 2220/18; B65D 2543/00194

(57) ABSTRACT

A container configured to hold fire extinguishing material and to be aerially deployable over a fire for releasing the fire extinguishing material over the fire includes a skid plate and a restraint strap coupled to the skid plate. A box assembly is positionable on the skid plate and includes a box body including a wall having an upper edge, with the restraint strap being connectable to the wall. A box strap is connected to the box body. A bag is positionable within the box body and is configured to receive the fire extinguishing material, with the bag being closable to retain the fire extinguishing material received therein. A lid is positionable on the box body, with the lid having a main panel and a lid strap connected to the main panel. The lid strap is connectable to the box strap to secure the lid to the box assembly.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

### 1. Technical Field

The present disclosure relates generally to a fire retardant deployment system, and in particular, a container for fire retardant that may be selectively deployed from an aircraft.

### 2. Description of the Related Art

Wild fires have increased in average size about 20% in recent years. In the last twenty years, the average size of a wild fire has increased by 60%. In the United States, the average cost of a wild fire is about 6.5 million dollars. Beyond the monetary cost, wild fires also have a significant and lasting environmental impact. In particular, every acre that is burned of medium density fuel, more than fifty tons of hydrocarbon and toxic gases may be released into the atmosphere.

Currently, to fight wild fires, an aircraft is used to deploy water and fire retardant chemicals at or around the wild fire to contain the wild fire or put out the wild fire. The aircraft serving to put out the wild fire is typically a retired aircraft serving a “second life.” The retired aircraft is reconfigured and maintained for single mission use, namely, fighting wild fires. The aircraft drops the water and/or fire retardant chemicals on the fire or locations around the fire to contain the fire. To this end, the aircraft flies very close to the ground location or target location to ensure that the water and fire retardant chemicals dispersed in the air reach the target location. If the aircraft is too high above the target location, then the dispersed water and/or fire retardant chemicals may be blown over a large area so that its concentration may be ineffective at containing the fire or putting out the fire. Accordingly, the aircraft must perform a maneuver wherein the aircraft flies very close to the ground or fire location. Unfortunately, due to this dangerous flight profile, the aircraft may operate only when visibility is clear, during daylight and within a limited daylight range. The aircraft cannot fly during night hours or during heavy winds. Additionally, when the fire is located within a canyon, the reduced daylight hours due to the canyon angles further limit the operational time of the aircraft. The weather and winds may also prevent or limit operation of the aircraft to deploy water and/or fire retardant chemicals.

Accordingly, there is a need in the art for an improved device, system and method for selectively delivering water, the liquid and/or other material to a target location. Various aspects of the present disclosure address this particular need, as will be discussed in more detail below.

### BRIEF SUMMARY

In accordance with one embodiment of the present disclosure, there is provided a container configured to hold fire extinguishing material and to be aerially deployable over a fire for releasing the fire extinguishing material over the fire. The container includes a skid plate, and a pair of restraint straps coupled to respective portions of the skid plate. A box assembly is positionable on the skid plate and includes a box body including a plurality of walls each having an upper edge. The pair of restraint strap are connectable to respective walls. The box assembly additionally includes a pair of box straps connected to the box body, with the pair of box straps being connected to respective ones of the pair of walls adjacent a common corner of the box body. A bag is positionable within the box body and is configured to receive the fire extinguishing material. The bag is closable to retain the fire extinguishing material received therein. A lid is positionable on the box body, with the lid having a main panel and a plurality of lid straps connected to the main panel. Each lid strap is connectable to one of the pair of box straps to secure the lid to the box assembly.

The skid plate may include two pairs of slots formed therein, and each restraint strap may be routed through the a respective one of the pair of slots and around a respective wall.

The container may additionally include a pair of rubber bands connected to skid plate and extendable over the lid and box assembly when the lid is positioned on the box body.

The container may also comprise a bag strap extendable around a portion of the bag to apply a closing force on the bag. The bag strap may include opposed end portions configured to be extendable through opposing portions of the box assembly. The box assembly may further comprise a pair of upper enclosure panels connected to the box body. Each upper enclosure panel may include a corner opening and a midline opening. The corner opening is configured to receive a respective one of the opposed end portions of the bag strap and the midline opening is configured to a portion of a respective one of the pair of restraint straps.

The bag may be included in a cassette having a support body connected to the bag. The support body may include a central panel and a pair of outside panels. The support body may be transitional between a folded configuration and an unfolded configuration. The pair of outside panels may overlap with each other when in the folded configuration, and the pair of outside panels may be coplanar with the central panel when in the unfolded configuration.

The lid straps may include a first pair of lid straps extending parallel to a first axis, and a second pair of lid straps extending parallel to a second axis angularly offset from the first axis.

According to another embodiment, there is provided a container configured to hold fire extinguishing material and to be aerially deployable over a fire for releasing the fire extinguishing material over the fire. The container includes a skid plate and a restraint strap coupled to the skid plate. A box assembly is positionable on the skid plate and includes a box body including a wall having an upper edge, with the restraint strap being connectable to the wall. A box strap is connected to the box body. A bag is positionable within the box body and is configured to receive the fire extinguishing material, with the bag being closable to retain the fire extinguishing material received therein. A lid is positionable on the box body, with the lid having a main panel and a lid strap connected to the main panel. The lid strap is connectable to the box strap to secure the lid to the box assembly.

According to yet another embodiment, there is provided a method of assembling a container configured to hold fire extinguishing material and to be aerially deployable over a fire for releasing the fire extinguishing material over the fire. The method includes placing a box assembly on a skid plate, the box assembly including a box body having a sidewall including an upper edge, and a box strap connected to the box body. The method additionally includes connecting the skid plate to the box body using a restraint strap, with the restraint strap extending from the skid plate, and toward the upper edge of the sidewall. The method also includes inserting a bag into the box body and filling bag with fire extinguishing material. The bag is closed by bunching a portion of the bag to enclose the fire extinguishing material within the bag. A closed portion of the bag is secured with a bag strap, and the bag strap is routed through opposed portion of the box assembly. A lid is applied to the box assembly.

The box assembly may include an upper enclosure panel having a midline opening formed therein, and the step of connecting the skid plate to the box body may include extending the restraint strap through the midline opening in the top enclosure.

The step of inserting the bag into the box body may include inserting a cassette having a support body connected to the bag into the box body. The step of inserting the bag into the box body may further include the step of unfolding the support body within the box body from a folded configuration to an unfolded configuration.

The method may additionally comprise the step of positioning a rubber band over the box body and the lid to urge the lid against the box body.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a container configured to hold a fire extinguishing material for aerial deployment over a fire;

FIG. 2 is an exploded view of the container of FIG. 1;

FIG. 3 is an upper perspective view of a box body being attached to a skid plate via a pair of restraint straps;

FIG. 4 is an upper perspective view of the box body attached to the skid plate and a pair of rubber bands temporarily extended over the box body;

FIG. 5 is an upper perspective view of a lid, cassette, and load retention blocks in a stowed configuration;

FIG. 6 is an upper perspective view of the cassette in a folded configuration being loaded in the box body;

FIG. 7 is an upper perspective view of the cassette being transitioned from the folded configuration toward the unfolded configuration within the box body;

FIG. 8 is an upper perspective view of a bag of the cassette being opened and an upper end thereof being draped over the top of the box body;

FIG. 9 is an upper perspective view of a filling hose filling the opened bag with fire retardant;

FIG. 10 is an upper perspective view of the bag being closed and a bag strap secured around a bunched portion of the bag

FIG. 11 is an upper perspective view of opposed end portions of the bag strap being routed through respective corner openings of by the box assembly;

FIG. 12 is a bottom view of a lid including a plurality of lid straps coupled thereto;

FIG. 13 is a lower perspective view of a plurality of lid straps extending between the lid and the box body and readied for attachment to a pair of box straps;

FIG. 14 is a perspective view of a first box strap connected to a first pair of lid straps;

FIG. 15 is a perspective view of a second box strap connected to a second pair of lid straps;

FIG. 16 is an upper perspective view of an assembled container readied for loading on an aircraft;

FIG. 17 is an upper perspective view of a container having an alternative embodiment of lengthened vertical restraint straps extendable over the lid, the vertical restraint straps being in a partially attached configuration; and

FIG. 18 is an upper perspective view of the container of FIG. 17, with the vertical restraint straps in a completely attached configuration.

Common reference numerals are used throughout the drawings and the detailed description to indicate the same elements.

### DETAILED DESCRIPTION

The detailed description set forth below in connection with the appended drawings is intended as a description of certain embodiments of an aerially deployable container of fire extinguishing material and is not intended to represent the only forms that may be developed or utilized. The description sets forth the various structure and/or functions in connection with the illustrated embodiments, but it is to be understood, however, that the same or equivalent structure and/or functions may be accomplished by different embodiments that are also intended to be encompassed within the scope of the present disclosure. It is further understood that the use of relational terms such as first and second, and the like are used solely to distinguish one entity from another without necessarily requiring or implying any actual such relationship or order between such entities.

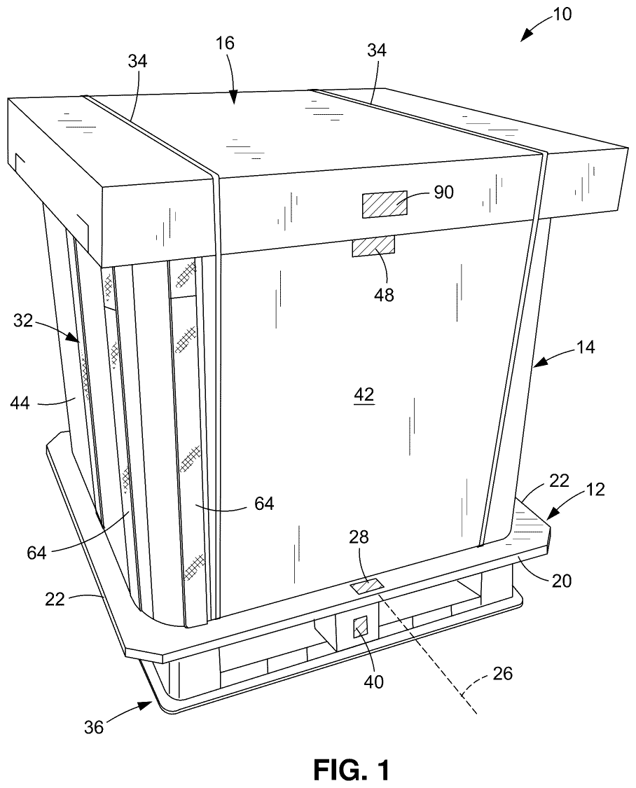

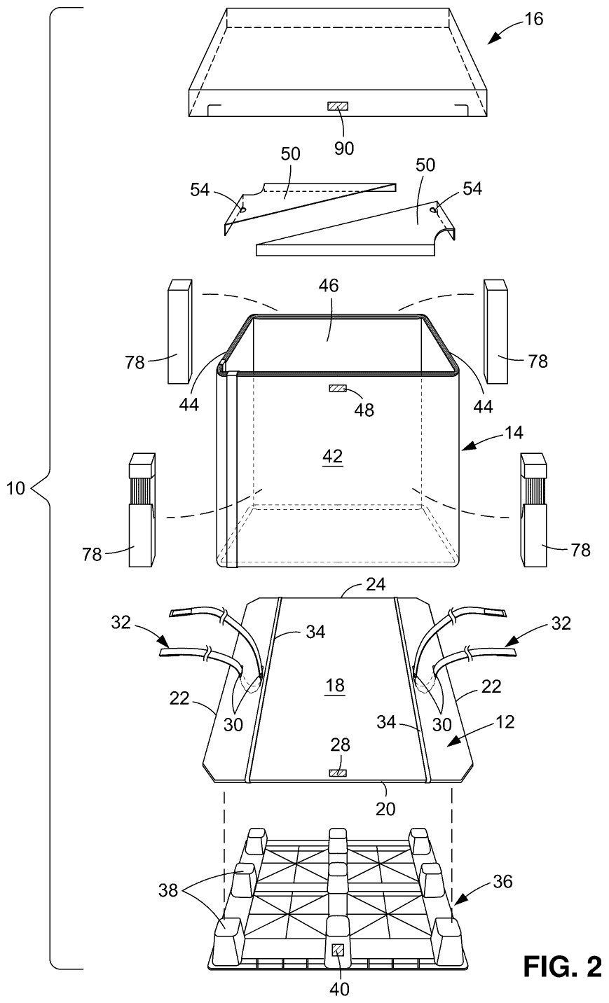

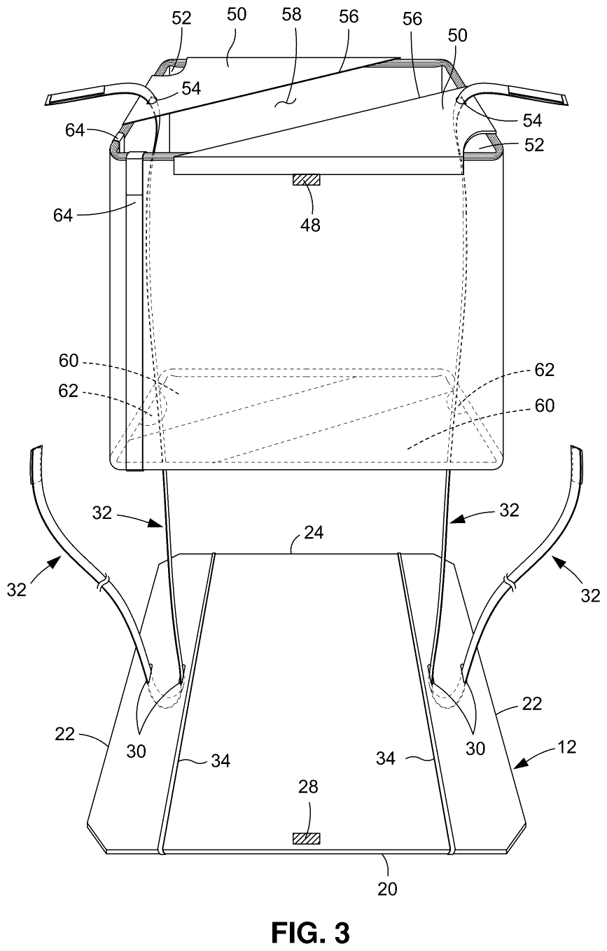

Referring now to the drawings wherein the showings are for purposes of illustrating preferred embodiments of the present disclosure, and are not for purposes of limiting the same, there is depicted a container 10 configured to hold fire extinguishing material and to be aerially deployable over a fire for releasing the fire extinguishing material over the fire. FIG. 1 is an upper perspective view of a container 10 that has been loaded and assembled, and is ready for deployment. The container 10 generally includes a skid plate 12, a box body 14, and a lid 16. The skid plate 12 may include a sheet of wood or other material having a planar upper surface 18 adapted to support the box body 14. The skid plate 12 may include a forward edge 20, a pair of side edges 22 and a rearward edge 24. The corners may be angled to avoid being sharp. The skid plate 12 may define a central axis 26 extending parallel to, and at a midpoint between the pair of side edges 22. A white mark 28, or other indicia, may be located on the upper surface 18 to facilitate alignment with the box body 14, as will be described in more detail below. The white mark (or other indicia) 28 may be tape, a sticker, printed, painted, or otherwise formed on the upper surface 18. The white mark 28 may be located on the central axis 26, midway between the pair of side edges 22 and slightly offset from the forward edge 20.

The skid plate 12 may additionally include two pairs of slots 30 extending through the skid plate 12 from the upper surface 18 to an opposing lower surface. Each pair of slots 30 is formed adjacent a respective side edge 22. The slots 30 in a given pair may extend parallel to each other, as well as extending parallel to the adjacent side edge 22. Each pair of slots 30 may accommodate a vertical restraint strap 32, with opposite end portions of the strap 32 extending upwardly through respective slots 30, such that a middle section of the strap 32 extend across the bottom surface of the skid plate 12. The details of the vertical restraint strap 32 will be explained in more detail below.

A pair of rubber bands 34 may also be attached to the skid plate 12, with the rubber bands 34 extending across the skid plate 12 from the forward edge 20 toward the rearward edge 24, in a direction that is generally parallel to the side edges 22. The rubber bands 34 may be used to help urge a lid 16 on the box body 14, as will be described in more detail below.

The skid plate 12 may be supported on an assembly deck 36, which may include a plurality of support pedestals 38 extending upwardly from a lower surface. The support pedestals 38 may include upper surfaces which are generally coplanar with each other to define a generally even support surface upon which the skid plate 12 may rest. The support pedestals 38 may be formed from plastic or other materials known in the art. A white mark 40, or other indicia, may be formed on an outer surface of a pedestal 38 that is adjacent an outer edge thereof, and is at an approximate midline of the assembly deck 36. The white mark 28 on the skid plate 12 may be aligned with the white mark 40 on the assembly deck 36 to facilitate easy alignment of the skid plate 12 on the assembly deck 36 in a preferred orientation.

The box body 14 may include four interconnected walls, including a forward wall 42, a pair of side walls 44 and a rear wall 46. The size of the walls 42, 44, 46 may be identical, or they may vary in dimension without departing from the spirit and scope of the present disclosure. According to one embodiment, each wall 42, 44, 46 defines a thickness of approximately 4 inches as the distance between an inner surface of the wall 42, 44, 46 and an outer surface of the wall 42, 44, 46. The walls 42, 44, 46 may be formed from a corrugated material, such as cardboard. In one implementation each wall 42, 44, 46 may include multiple layers of corrugated panels adhered via polyvinyl acetate (PVA) glue to provide support against undesired deflection.

The box body 14 may have an open upper end and an open lower end, with the lower end being placeable on top of the upper surface 18 of the skid plate 12. The box body 14 defines an internal cavity between the upper and lower ends, with the cavity being sized to receive the fire retardant material, as will be described in more detail below. In one embodiment, the box body 14 may be formed of several layers of corrugated cardboard panels. The vertical panel orientation may provide greater than 120 inches of adhesion and restraint in a shear direction.

The forward wall 42 may include a white mark 48, or other indicia, formed thereon to facilitate desired alignment with the skid plate 12. In this regard, the side of the box body 14 having the white mark 48 may be placed facing the white mark 28 on the skid plate 12. With the outer edge of the box body 14 being placed along an inner edge of the white mark on the skid plate 12. It is contemplated that the white mark 28 may be located adjacent the top or bottom of the box body 14 to help the assembly personnel readily identify which side is intended to be the top and which side is intended to be the bottom.

A pair of upper enclosure panels 50 may be coupled to the box body 14 and may extend over a portion of the open upper end thereof. Each partial enclosure panel 50 may extend from one wall to an adjacent wall near the corner between the two walls. The enclosure panel 50 may include a pair of attachment flaps that may be glued or otherwise adhered to a respective wall. The enclosure panels 50 may be sized and configured such that a corner opening 52 may be formed at the corner (e.g., where the two walls of the box body 14 meet), and a midline opening 54 may be formed adjacent a midline of one of the walls. The purposes of the openings 52, 54 will be described in more detail below.

Each upper enclosure panel 50 may include a medial edge 56 that extends from one wall to the adjacent wall. The two medial edges 56 of the pair of enclosure panels 50 may be generally parallel to each other to define a diagonal opening 58 extending between a pair of corners that are opposite each other, e.g., not adjacent each other. A squaring device (not shown) may be used to square the box body 14 during assembly, with the squaring device extending within the diagonal opening 58 between the opposed corners.

The box body 14 may also include one or more lower panels 60 extending from a lower end of one or more walls 42, 44, 46 of the box body 14. The lower panels 60 may be similar in configuration to the upper enclosure panels 50 to the extent that each lower panel 60 may include a midline opening 62 at formed adjacent a midline of one of the walls 42, 44, 46. The midline openings 54, 62 in the upper and lower panels 50, 60 may be aligned with each other along a midline axis.

The upper enclosure panels 50 and lower panels 60 may be configured to extend over more than 65% of the top and bottom of the box body 14, which may enhance the overall structural integrity of the assembled container 10.

A pair of box straps 64 may be coupled to the box body 14 adjacent one corner thereof. Each box strap 64 may extend over an outer surface, over an upper edge, over an inner surface, and around a lower edge of a given wall. In one embodiment, the box straps 64 may be secured to a surface of the boxy body 14 via tape, such as gaffer tape, or via adhesives or other securement modalities known in the art. Each box strap 64 may also be sized and configured to include a free segment, having hook and loop (e.g., VELCRO) fastening material thereon for attaching to a bag that is to be placed in the box body 14 which contains the fire retardant material, as will be discussed below.

Once the box body 14 is squared/opened on the skid plate 12, the vertical restraint straps 32 may be used to attach the box to the skid plate 12. In this regard, the segment of the vertical restraint strap 32 passing through the medial-most slot 30 in a given pair of slots 30 on the skid plate 12 may be advanced through a midline 62 opening in a lower panel 60, and a midline opening 54 in an upper panel 50. That segment of the vertical restraint strap 32 may be connected to the segment of the vertical restraint strap 32 extending through the lateral-most slot 30 in the skid plate 12. The ends of the vertical restraint strap 32 may include hooks and loops fastener material to facilitate quick and easy attachment of the strap segments to each other. Once the ends of the vertical restraint strap 32 are connected to each other, the vertical restraint strap 32 will extend around a respective wall of the box body 14. This process is repeated for the other vertical restraint strap 32 around the opposing wall on the box body 14. As this process is completed, the assembly personnel should ensure that the box body 14 remains properly aligned with the skid plate 12.

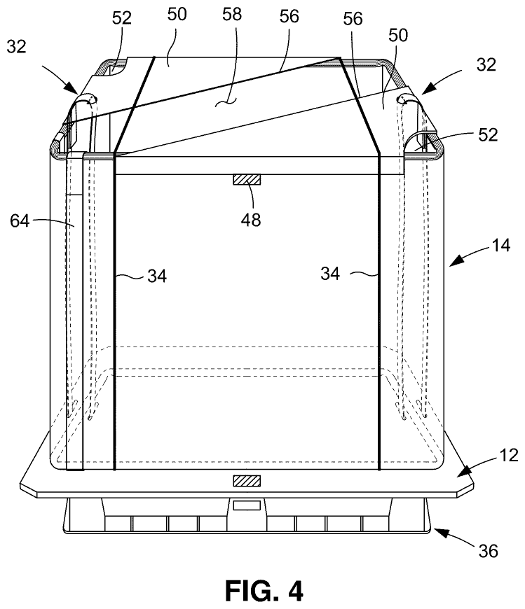

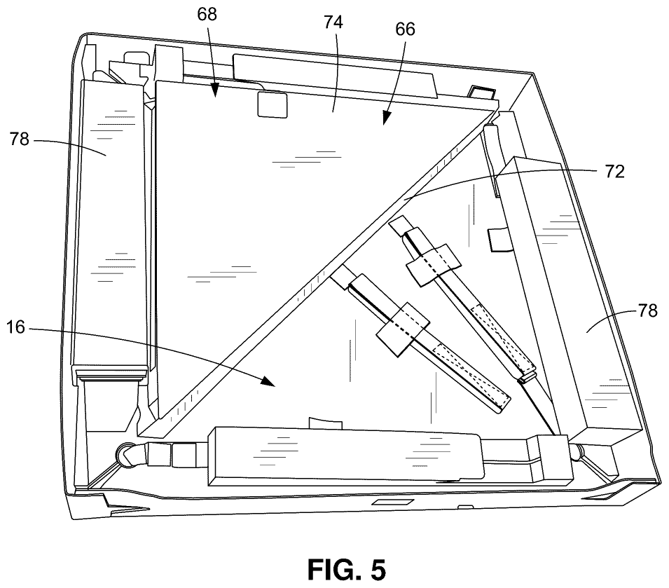

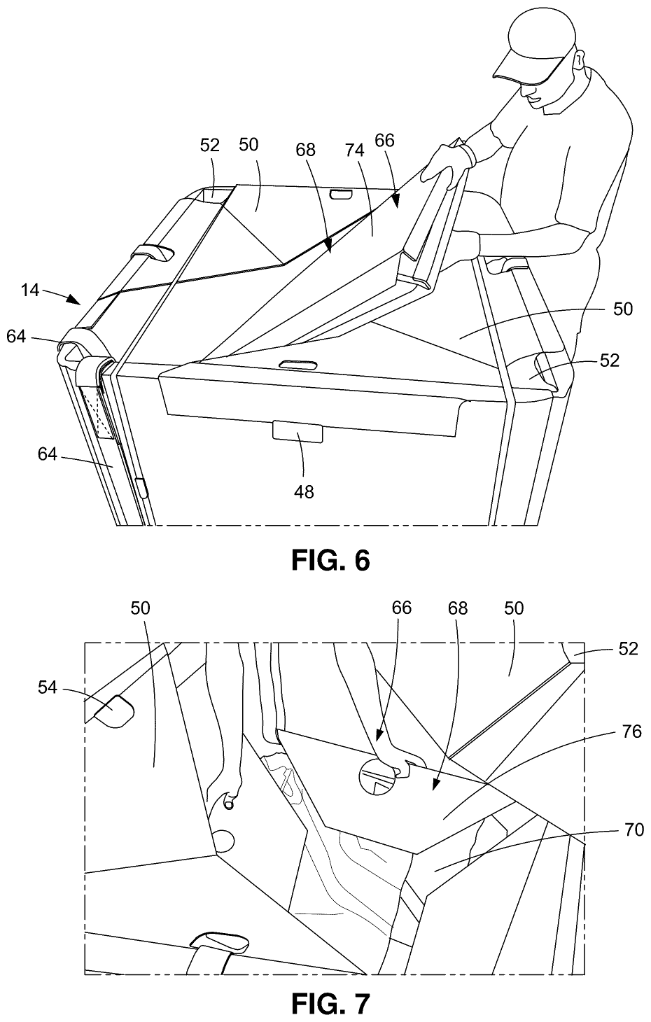

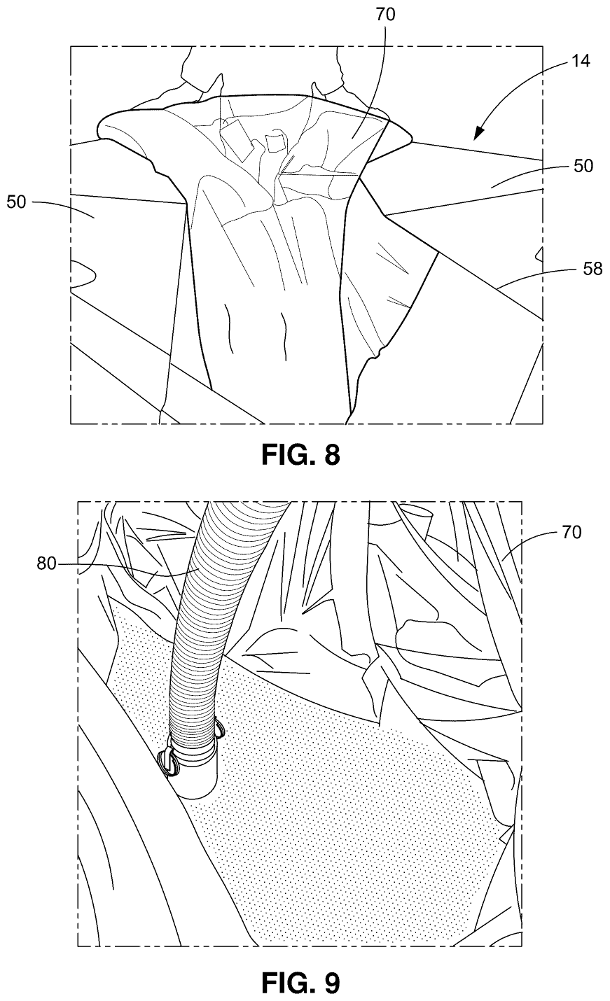

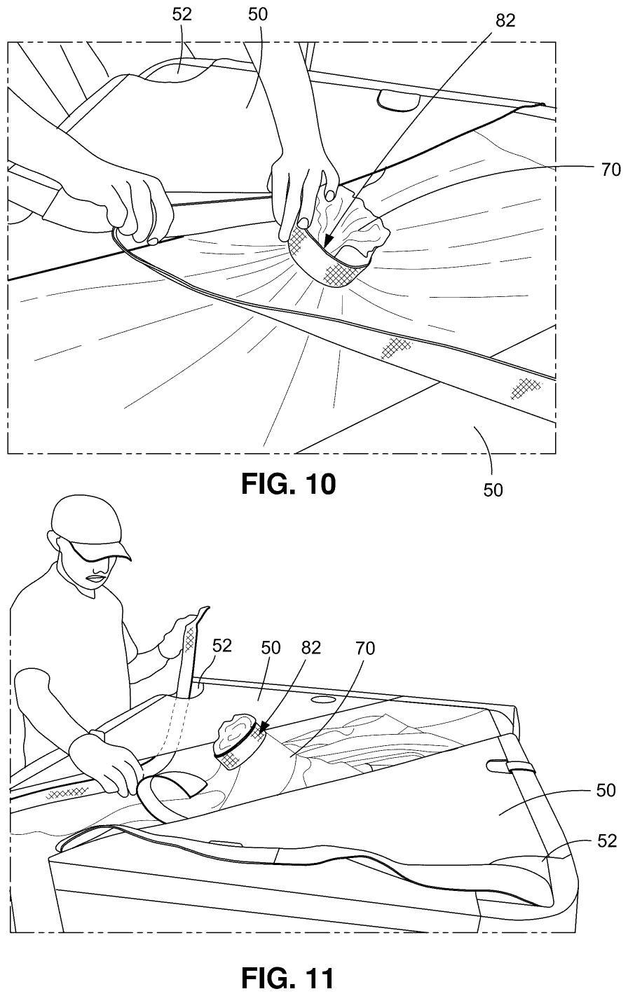

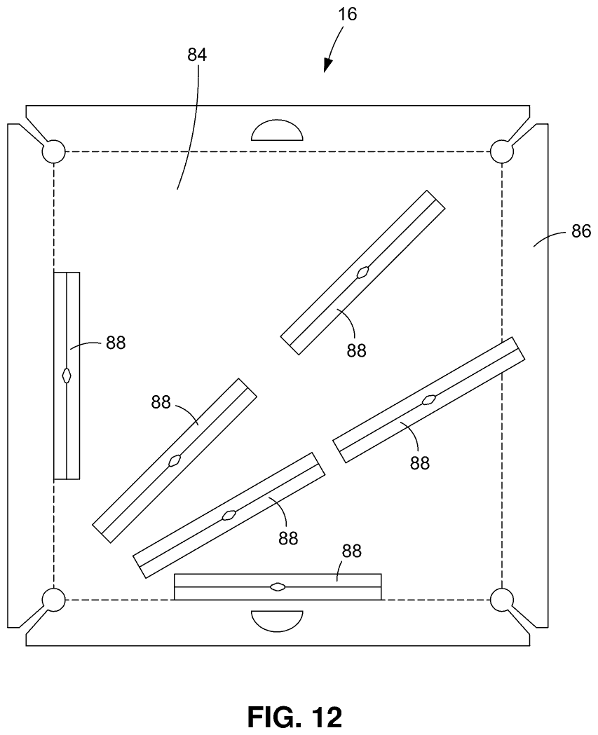

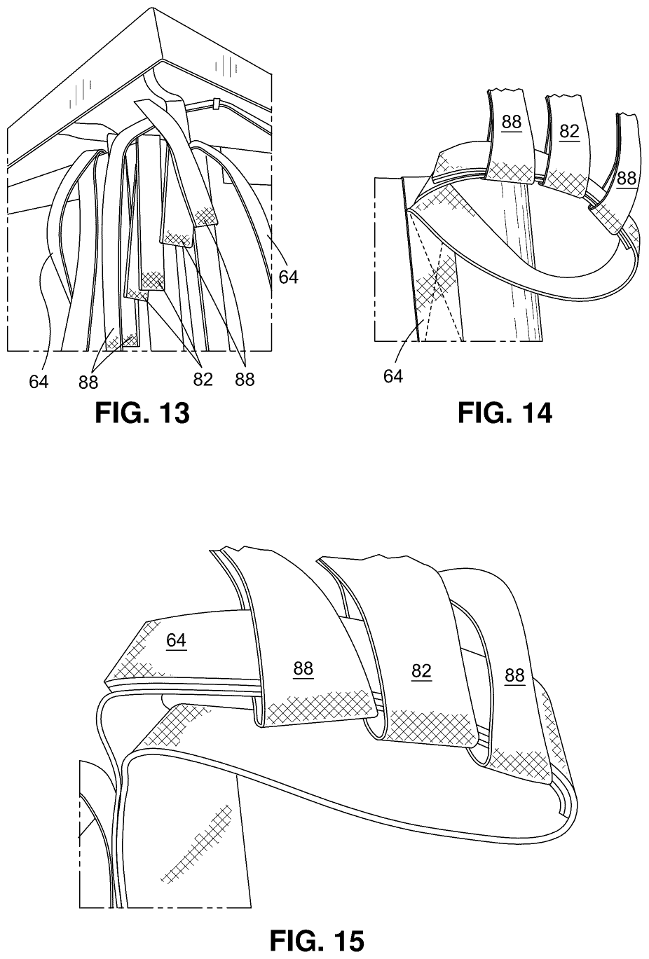

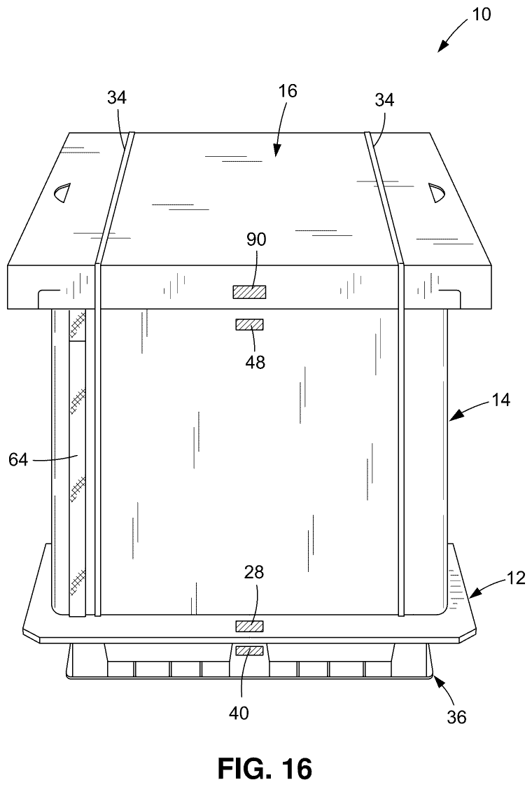

Once the vertical restraint straps 32 are connected to the box body 14, the rubber bands 34 may be temporarily placed around the box body 14, as is depicted in FIG. 4. In this regard, each rubber band 34 may be pulled from the bottom of the skid plate 12 and stretched over the upper edge of the box body 14. The bottom of the rubber bands 34 may remain stretched across the bottom of the box body 14. This configuration of the rubber bands 34 may be temporary, until a lid 16 is placed over the box body 14.

Loading of the container 10 with fire retardant may include the use of a cassette 66 that may be initially folded for ease of transport, but may be unfolded when loaded in the box body 14. The cassette 66 may include a support body 68 and a bag 70 coupled to the support body 68. The bag 70 may include a closed end portion and an open end portion, with the closed end portion being adhered to, or otherwise attached to, the support body 68. The bag 70 may be folded into the support body 68 until the bag 70 is opened prior to filling.

The support body 68 may include a central panel 72, a pair of outside panels 74, and four interior panels 76. The outside panels 74 may be generally triangular in shape, with one end of the triangle being attached to the central panel 72, and the other ends of the triangle being attached to respective interior panels. The support body 68 may be selectively transitional between a folded configuration and an unfolded configuration. In the folded configuration, the pair of outside panels 74 overlap each other, with the central panel 72 being positioned along outer edges of the outside panels 74. As the support body 68 transitions from the folded configuration toward the unfolded configuration, the pair of outside panels 74 move away from each other until the central panel 72 and the pair outside panels 74 are generally co-planar relative to each other. Thus, the support body 68 may be in the folded configuration to assume a smaller footprint, which may be desirable during storage and transport, prior to use. A piece of tape may extend between the pair of outside panels 74 to hold the support body 68 in the folded configuration. The tape may be removed to allow the support body 68 to transition from the folded configuration toward the unfolded configuration.

When assembling the container 10, the support body 68 may be inserted into the box body 14 in the folded configuration, and then transitioned from the folded configuration to the unfolded configuration when inside the box body 14. In particular, the assembly personnel arrange the support body 68 such that the support body 68 assumes a nested configuration within the box body 14, with the corners of the support body 68 being moved into the corners of the box body 14. The box body 14 may be sized and configured such that the depth of the box body 14 may be large enough such that positioning the unfolded support body 68 into the bottom of the box body 14 may be facilitated by the use of a block 78 or other elongated structure to help the assembly personnel push the support body 68 into proper position.

With the support body 68 in the proper position in the box body 14, the bag 70 may be unfolded and opened within the box body 14. The open end of the bag 70 may be grabbed with a grabber (not shown) to help the assembly personnel reach the bag 70. The open end of the bag 70 is pulled up so that the bag 70 extends over the top of the box body 14. The bag 70 may include seams running along opposed vertical portions of the bag 70 when the bag 70 is opened and pulled out over the top of the box body 14. The seams may be located such that the seams of the bag 70 are positioned adjacent opposite corners of the box body 14 that are included in the diagonal opening 58 and are spaced from the upper enclosure panels 50. The open top portion of the bag 70 may be draped over the top of the box body 14.

With the box body 14 placed on the skid plate 12, and the white marks 40, 28, 48 on the assembly deck 36, skid plate 12, and box body 14 aligned with each other, the box body 14 can be filled with the fire retardant material, as described below. Once the box body 14 is loaded, it is difficult to adjust the position of the box body 14 on the skid plate 12, as the weight of the contents placed in the box body 14 may make it extremely difficult to adjust the box body 14 relative to the skid plate 12.

The fire retardant may be filled in the bag 70 using a supply hose 80, as shown in FIG. 9, with the supply hose 80 being connected to a supply of fire retardant. A valve controlling the flow of fire retardant may be opened to allow the retardant to fill into the bag 70. The fill nozzle on the hose 80 may be positioned below the surface of the dispensed retardant of the contents begin to foam. The retardant may be filled to a maximum fill line indicated inside the box body 14, unless a reduced fill is indicated as appropriate by specific aircraft or mission requirements.

After the bag 70 has been filled, a closing procedure includes lifting the edges of the bag 70 up over the top of the box body 14. At a corner of the bag 70, or at a select portion of the bag 70, while slightly pulling up, a user begins to bundle the top of the bag 70 into the corner or select portion. This is repeated until the entire upper edge of the bag 70 has been lifted and bundled. Air is pushed out of the bag 70 by pressing down on the top of the bundled bag 70 to urge any air out of the bag 70. During the process, the assembly personnel ensure that while air can escape due to the force applied to the bag 70, the bundled end may be kept level with the surface of the contents to prevent air from re-entering.

The bundled end of the bag 70 may be folded and twisted into a U-shape and then compressed. A bag strap 82 may be wrapped around the bundled end of the bag 70. In this regard, the bag strap 82 may be an elongate strap having a pair of end segments, and a middle segment. The middle segment used at this point to wrap around the bunded end of the bag 70 and connect to itself. Hooks and loops fastening material may be included on the middle segment to facilitate connection of the middle segment to itself after being wrapped around the bag 70. The connected bag strap 82 may prevent the bundled end from inadvertently becoming unbundled prior to deployment.

The rubber bands 34 may be removed from the top of the box body 14 and placed adjacent the box body 14 on the skid plate 12. One end segment of the bag strap 82 is routed under the upper panel 50 and through a corner opening 52, while the other end of the bag strap 82 is routed under the opposite upper panel 50 and through the opposite corner opening 52.

The container 10 further includes a lid 16 having a main wall 84 including an upper surface and a bottom surface, and a sidewall 86 extending around the main wall 84. The lid 16 may include a plurality of lid straps 88 connected thereto. Each lid strap 88 may extend along a respective axis, or alternatively, respective pairs of lid straps 88 may extend along a common axis. The lid straps 88 may be used to operatively connect the lid 16 to the box body 14 and the bag 70, as will be described in more detail below. The lid 16 may include a white mark 90, or other indicia thereon, such that the white mark 90 on the lid 16 may be aligned with the white mark 90 on the box body 14 to properly orient the lid 16 relative to the box body 14. The lid 16 is partially placed on top of the box body 14, with the corner of the lid 16 adjacent the box straps 64 being propped slightly upwardly to access lid straps 88. The squaring device or other easily accessible tool may be used to prop the lid 16 by placing the tool between the lid 16 and the box body 14. The lid straps 88 may be different colors, with one pair being white, and another pair being black. The different colored lid straps 88 may be structurally similar, and the different colors may facilitate proper rigging of the lid straps 88 in a completed loop and the bag rigging strap 82 to enable simultaneous tearing of the box enclosures while opening the twisted knot on top of the bag 70. A primary length of all of the lid straps 88 may extend along a length of the bottom surface of the lid 16, while each lid strap 88 may also include a free end that may be extendable to drape over the corner of the box body 14 adjacent the box straps 64. The free end of each lid strap 88 may include a loop, through which a free end of the box straps 64 may be routed. In particular, the free end of the bag strap 82 may be routed through a white cap strap, followed by a loop in the bag strap 82, then followed by another white strap. The process is repeated using the black lid straps 88 and the other end of the bag strap 82, with the box strap 64 being routed through a black lid strap 88, the bag strap 82, and the other black lid strap 88. Although the foregoing describes two pairs of lid straps 88, different numbers of lid straps 88 may be used without departing from the spirit and scope of the present disclosure. Along these lines, adding lid straps 88 may increase the distance that a container 10 may remain intact after deployment, while reducing lid straps 88 may decrease the distance that a container 10 may remain intact after deployment. Thus, for drops at higher altitude, more straps may be needed, and for drops at a lower altitude, fewer straps may be needed. In any case, it may be desirable to have an even number of straps to allow for an even, balanced movement of the container 10 after the container 10 exits the aircraft.

All of the loose portions of the lid straps 88 may be tucked under the lid 16, and the lid 16 is secured down on the box body 14. The rubber bands 34 are then placed over the lid 16 to hold the lid 16 in place against the box body 14.

The lid straps 88 and bag strap 82 may be formed from polyethylene terephthalate (PET) material or other similar materials known in the art. In one particular embodiment, the PET straps may be spec #1281WH2, 1281GR2 and 1281BK2. The strap width may be 47 mm, the strap caliper may be 1.0 mm, and the tensile strength may be 2,900 pounds. The straps may be configured to withstand −1.1 G-force for 0.1 second. The combined containment impact of increased bands and box enclosures may capable of withstanding more than −1.5 G-forces for 0.1 second.

The weight of the assembled container 10 when filled with water may be approximately 960 kg or 2,116 pounds (Tar 47.6 kg/105 lbs).

The assembled container 10 may be loaded onto an aircraft for deployment over a fire. The aircraft may be configured to deploy the container(s) 10 from the rear of the aircraft, wherein the container 10 may be guided along a deployment guide rail on the aircraft until the container 10 falls from the rear of the aircraft. The opening sequence upon airdrop may be initiated by the lid 16 through the velcro connected/linked straps 88, 82. Upon entry of the container 10 into the slipstream of the aircraft, the fast-moving airflow applies a rapid “shock” and deceleration to the container 10. Simultaneously tearing open the box enclosures exposes the bag 70, as the twisted knot rigging strap 82 is then released and the entire top of the bag 70 is opened, exposing the payload. This action may cause the lid straps 88 to transition to a completely extended configuration, which may exert an asymmetrical rotational force on the reverse threaded box straps 64 located on a single corner of the box body 14. This acts to eject the payload and bag 70 from the box body 14 in a forward and downward trajectory along the line of the intended drop zone. As a secondary “fail-safe” payload deployment measure in the design, the lid deceleration pressure may be sufficient to tear the box body 14 at the corner where the box straps 64 are threaded if the payload is not released/ejected in the initial opening sequence. This tearing and opening of the box body 14 at the corner will eject the bag 70 and release the payload in a consistent pattern with the rest of the units being dropped. The straps connecting the components upon payload release are then out of tension and the tethered components descend to the ground under the lid 16 as the lid 16 acts as a partial parachute (e.g., increases drag to slow descent).

The straps used in the container 10 may provide several benefits over conventional aerial retardant deployment systems. In particular, the vertical restraint straps 32, while providing functional advantages in securing the box body 14 to the skid plate 12, adds minimal weight to the container 10. Furthermore, the vertical restraint straps 32 work in concert with the container enclosures and rubber bands 34 to provide vertical gravitational force stability. Furthermore, the color coding of the bands may help to simplify rigging and having a minimal impact on assembly time.

It is contemplated that any color scheme disclosed herein is for purposes of illustration and not for purposes of limiting the scope of the present disclosure. In this regard, any color mentioned herein may be replaced with any other color, as may be desired.

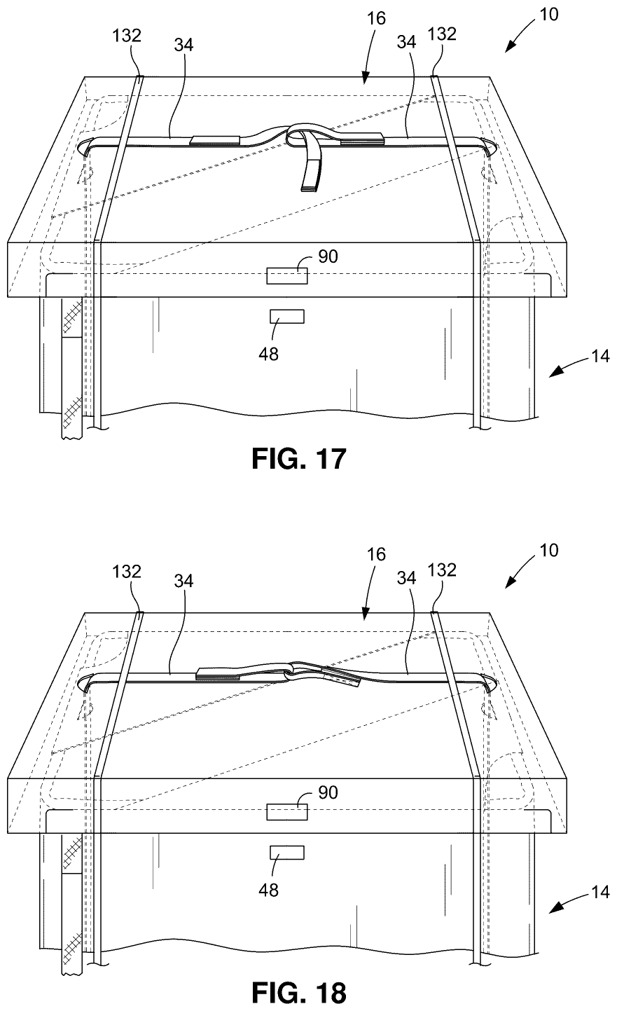

Referring now to FIGS. 17 and 18, there is depicted an alternative embodiment of the container with extended vertical restraint straps 132 configured to extend over the top of the lid 16, rather than just extending over the top edge of the box body 14. In one implementation, the vertical restraint straps 132 may extend through respective opposed side portions of the lid 16 before extending over the outer, upper surface of the lid 16 before being connected to each other. The vertical restraint straps 132 would be undone prior to the drop to enable the lid to come off the box body during deployment. This configuration may eliminate the need for type 26 straps to be placed over the containers while in the aircraft.

The particulars shown herein are by way of example only for purposes of illustrative discussion, and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

What is claimed is:

1. A container configured to hold fire extinguishing material and to be aerially deployable over a fire for releasing the fire extinguishing material over the fire, the container comprising:
a skid plate;
a pair of restraint straps coupled to respective portions of the skid plate;
a box assembly positionable on the skid plate, the box assembly having:
a box body including a plurality of walls each having an upper edge, the pair of restraint strap being connectable to respective walls; and
a pair of box straps connected to the box body, the pair of box straps being connected to respective ones of the pair of walls adjacent a common corner of the box body;
a bag positionable within the box body and configured to receive the fire extinguishing material, the bag being closable to retain the fire extinguishing material received therein; and
a lid positionable on the box body, the lid having a main panel and a plurality of lid straps connected to the main panel, each lid strap being connectable to one of the pair of box straps to secure the lid to the box assembly.

2. The container recited in claim 1, wherein the skid plate includes two pairs of slots formed therein, each restraint strap being routed through the a respective one of the pair of slots and around a respective wall.

3. The container recited in claim 1, further comprising a pair of rubber bands connected to skid plate and extendable over the lid and box assembly when the lid is positioned on the box body.
The container recited in claim 1, further comprising a bag strap extendable around a portion of the bag to apply a closing force on the bag, the bag strap including opposed end portions configured to be extendable through opposing portions of the box assembly.

5. The container recited in claim 4, wherein the box assembly further comprises a pair of upper enclosure panels connected to the box body, each upper enclosure panel including a corner opening and a midline opening, the corner opening being configured to receive a respective one of the opposed end portions of the bag strap and the midline opening being configured to a portion of a respective one of the pair of restraint straps.

6. The container recited in claim 1, wherein the bag is included in a cassette having a support body connected to the bag.

7. The container recited in claim 6, wherein the support body includes a central panel and a pair of outside panels, the support body being transitional between a folded configuration and an unfolded configuration, the pair of outside panels overlapping with each other when in the folded configuration, and the pair of outside panels being coplanar with the central panel when in the unfolded configuration.

8. The container recited in claim 1, wherein the lid straps include a first pair of lid straps extending parallel to a first axis, and a second pair of lid straps extending parallel to a second axis angularly offset from the first axis.

9. A container configured to hold fire extinguishing material and to be aerially deployable over a fire for releasing the fire extinguishing material over the fire, the container comprising:
a skid plate;
a restraint strap coupled to the skid plate;
a box assembly positionable on the skid plate, the box assembly having:
a box body including a wall having an upper edge, the restraint strap being connectable to the wall; and
a box strap connected to the box body;
a bag positionable within the box body and configured to receive the fire extinguishing material, the bag being closable to retain the fire extinguishing material received therein; and
a lid positionable on the box body, the lid having a main panel and a lid strap connected to the main panel, the lid strap being connectable to the box strap to secure the lid to the box assembly.

10. The container recited in claim 9, wherein the skid plate includes a pair of slots formed therein, the restraint strap being routed through the pair of slots and around the wall.

11. The container recited in claim 9, further comprising a rubber band connected to skid plate and extendable over the lid and box assembly when the lid is positioned on the box body.

12. The container recited in claim 9, further comprising a bag strap extendable around a portion of the bag to apply a closing force on the bag, the bag strap including opposed end portions configured to be extendable through opposing portions of the box assembly.

13. The container recited in claim 12, wherein the box assembly further comprises a pair of upper enclosure panels connected to the box body, each upper enclosure panel including a corner opening and a midline opening, the corner opening being configured to receive a respective one of the opposed end portions of the bag strap and the midline opening being configured to receive a portion of the restraint strap.

14. The container recited in claim 9, wherein the bag is included in a cassette having a support body connected to the bag.

15. The container recited in claim 14, wherein the support body includes a central panel and a pair of outside panels, the support body being transitional between a folded configuration and an unfolded configuration, the pair of outside panels overlapping with each other when in the folded configuration, and the pair of outside panels being coplanar with the central panel when in the unfolded configuration.

16. A method of assembling a container configured to hold fire extinguishing material and to be aerially deployable over a fire for releasing the fire extinguishing material over the fire, the method comprising the steps of:
placing a box assembly on a skid plate, the box assembly including a box body having a sidewall including an upper edge, and a box strap connected to the box body;
connecting the skid plate to the box body using a restraint strap, the restraint strap extending from the skid plate, and toward the upper edge of the sidewall;
inserting a bag into the box body;
filling bag with fire extinguishing material;
close bag by bunching a portion of the bag to enclose the fire extinguishing material within the bag;
securing a closed portion of the bag with a bag strap;
routing the bag strap through opposed portion of the box assembly; and
applying a lid to the box assembly.

17. The method as recited in claim 16, wherein box assembly includes an upper enclosure panel having a midline opening formed therein, the step of connecting the skid plate to the box body includes extending the restraint strap through the midline opening in the top enclosure.

18. The method as recited in claim 16, wherein the step of inserting the bag into the box body includes inserting a cassette having a support body connected to the bag into the box body.

19. The method as recited in claim 18, wherein the step of inserting the bag into the box body further includes the step of unfolding the support body within the box body from a folded configuration to an unfolded configuration.

20. The method recited in claim 16, further comprising the step of positioning a rubber band over the box body and the lid to urge the lid against the box body.
